(19) United States
(12) Patent Application Publication
(10) Pub. No.: US 2015/0042241 A1
(43) Pub. Date: Feb. 12, 2015

(54) LIGHT EMITTING DEVICE

(71) Applicant: Lextar Electronics Corporation, Hsinchu (TW)

(72) Inventors: Chen-Yi Su, Taoyuan City (TW); Yung-Long Jian, New Taipei City (TW)

(73) Assignee: Lextar Electronics Corporation, Hsinchu (TW)

(21) Appl. No.: 14/256,030

(22) Filed: Apr. 18, 2014

(30) Foreign Application Priority Data
Aug. 12, 2013 (TW) 102128860

(51) Int. Cl. H05B 33/08

(52) U.S. Cl. CPC H05B 33/0857
USPC 315/294

(57) ABSTRACT

A light emitting device comprising a carrier board, a first group of light emitting elements, a second group of light emitting elements and a driver circuit. The first group of light emitting elements includes a plurality of first LEDs disposing on the carrier board and are used for emitting a first color temperature light. The second group of light emitting elements includes a plurality of second LEDs disposing on the carrier board and are used for emitting a second color temperature light. The first LEDs and the second LEDs are disposed in an alternative arrangement. The driver circuit output a first and a second driving current to drives the first LED and the second LED respectively. When the first driving current is the maximum, the second driving current is the minimum, and vice versa. The minimum of the first driving current and the second driving current is not zero.

This application claims the benefit of Taiwan application Serial No. 102128860, filed Aug. 12, 2013, the subject matter of which is incorporated herein by reference.

### BACKGROUND OF THE INVENTION

1. Field of the Invention

The invention relates in general to a light emitting device, and more particularly to a light emitting diode (LED) device.

2. Description of the Related Art

Light emitting diode (LED) having the advantages of high light emitting efficiency, long lifespan, robustness, fast response rate and high reliability has become a commonly used light source in lighting and electronic device. In practical use, several LEDs are combined together to increase brightness and efficiency for emitting light.

In response to the trend of slimness, lightweight and compactness of electronic device, the design of LED light source is also directed towards lightweight and slimness. However, when the distance between the LED body and the lamp mask is too short, the emitting light will generate bright band and dark band, the so called “Hotspot”, and deteriorate light uniformity. Furthermore, brightness and lifespan may even be reduced because the heat is over concentrated.

### SUMMARY OF THE INVENTION

The invention is directed to a light emitting device with excellent light uniformity.

According to one embodiment of the present invention, a light emitting device comprising a carrier board, a first group of light emitting elements, a second group of light emitting elements and a driver circuit is provided. The first group of light emitting elements comprises a plurality of first LEDs disposed on the carrier board and used for emitting the first color temperature light. The second group of light emitting elements comprises a plurality of second LEDs disposed on the carrier board and used for emitting the second color temperature light. The first LEDs and the second LEDs are disposed in an alternative arrangement. The driver circuit outputs a first driving current and a second driving current to drive the first LEDs and the second LEDs respectively. When the first driving current is the maximum, the second driving current is the minimum but not equal to zero. When the second driving current is the maximum, the first driving current is the minimum but not equal to zero.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a light emitting device according to an embodiment of the invention.

FIG. 2 is an equivalent circuit diagram of the light emitting device of

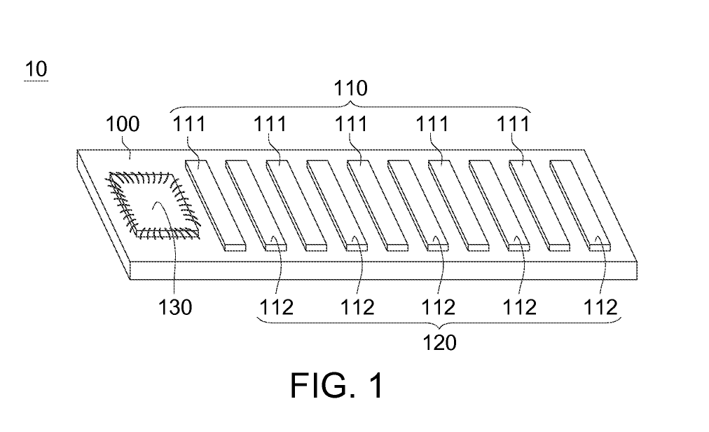

FIG. 1.

### DETAILED DESCRIPTION OF THE INVENTION

Referring to FIG. 1, a schematic diagram of a light emitting device according to an embodiment of the invention is shown. The light emitting device 10 comprises a carrier board 100, a first group of light emitting elements 110, a second group of light emitting elements 120 and a driver circuit 130. The first group of light emitting elements is formed by a plurality of first LEDs 111 and is used for emitting a first color temperature light. The second group of light emitting elements is formed by a plurality of second LEDs 112 and is used for emitting a second color temperature light. Two groups of LEDs with different color temperatures are used to mix light. The first LEDs 111 and the second LEDs 112, which can be realized by the same or different LEDs, are disposed on the carrier board 100 at an interval in an alternative arrangement. The driver circuit 130 is disposed on the carrier board 110 for providing currents to the first and the second light emitting units 110 and 120. In the present embodiment, the first LEDs 111 and the second LEDs 112 are arranged in a straight line to form a light bar. In other embodiment, the first LEDs 111 and the second LEDs 112 can also be arranged as a plane, a circle or any other shapes. In the present embodiment, the quantity of first LEDs 111 is the same as that of second LEDs 112 (both are 5 LEDs). However, the quantity of the first LEDs 111 can be different that of the second LEDs 112 in other embodiments. For instance, 4 second LEDs 112 are alternately arranged among 5 first LEDs 111. The invention does not restrict the quantity and arrangement shape of LEDs, and any quantities and arrangement shapes can do as long as the first LEDs 111 and the second LEDs 112 are disposed in an alternative arrangement.

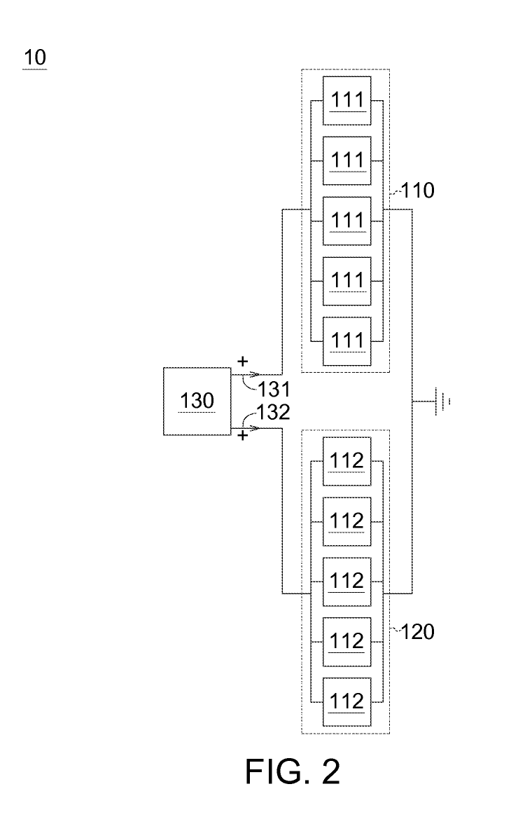

Referring to FIG. 2, an equivalent circuit diagram of the light emitting device of FIG. 1 is shown. The first group of light emitting elements 110 and the second group of light emitting elements 120 are in parallel. In an embodiment, each first LED 111 of the first group of light emitting elements 110 is in parallel, and each second LED 112 of the second group of light emitting elements 110 is also in parallel. In other words, the current flowing through each first LED 111 is the same and the current flowing through each second LED 112 is also the same.

As indicated in FIG. 2, the driver circuit 130 is a double output driver circuit. The double output driver circuit is capable of outputting a first driving current 131 to drive the first group of light emitting elements 110 and a second driving current 132 to drive the second group of light emitting elements 120. The magnitude of the first driving currents is equivalent to or different from that of the second driving current. The magnitude of the first and the second driving currents can be independently modulated through a color temperature controlling interface (not illustrated) coupled to the driver circuit 130.

In addition, the color temperature controlling interface can provide different driving currents to the first group of light emitting elements 110 and the second group of light emitting elements 120 to mix light. In an embodiment, the first color temperature light emitted from the first LEDs 111 is warm white, and the second color temperature light emitted from the second LEDs 112 is cool white. In an embodiment, the first color temperature light emitted from the first LEDs 111 is cool white, and the second color temperature light emitted from the second LEDs 112 is warm white.

Suppose the first color temperature light emitted from the first LEDs 111 of the first group of light emitting elements 110 is warm white (color temperature 2700-3000K) and the second color temperature light emitted from the second LEDs 112 of the second group of light emitting elements 120 is cool white (color temperature 6000-6500K) and the output ratio between the first driving current and the second driving current is 7:3. Then, the first color temperature light and the second color temperature light can be mixed to obtain a near pure white light (color temperature 4000-5000K).

Apart from the above mixing light mode, single color temperature mode, such as the first color temperature mode or the second color temperature mode, can be selected through the color temperature controlling interface. When the first color temperature mode is selected, the first driving current is the maximum and is used to drive the first color temperature light (such as warm white) emitted from the first LEDs 111 of the first group of light emitting elements 110. However, to avoid dark band occurring between every two first LEDs 111, a tiny amount of second driving current is outputted to the second LEDs 112, wherein the second driving current is the minimum but not equal to zero. Therefore, in the first color temperature mode, the first driving current is the maximum and the second driving current is the minimum but not equal to zero. For instance, the output ratio between the first driving current and the second driving current is 100:5. Thus, the second LEDs 112 (referring to FIG. 1) between two first LEDs 111 compensates the dark band between two first LEDs 111 with low brightness to increase overall light uniformity of the light emitting device 10. Since a second LED 112 used for compensating brightness is contained between every two first LEDs 111, the interval between LEDs does not need to be too small, so that manufacturing complexity and cost can be reduced. In practical application, the interval between LEDs can be adjusted according to actual needs.

Similarly, when the second color temperature mode is selected, the second driving current is the maximum, and is used to drive the second color temperature light (such as cool white) emitted from the first LEDs 112 of the second group of light emitting elements 120. However, to avoid dark band occurring between every two second LEDs 112, a tiny amount of first driving current is outputted to the first LEDs 111, wherein the first driving current is the minimum but not equal to zero. Therefore, in the second color temperature mode, the second driving current is the maximum and the first driving current is the minimum but not equal to zero. For instance, the output ratio between the second driving current and the first driving current is 100:5.Thus, the first LEDs 111 (referring to FIG. 1) between two second LEDs 112 compensates the dark band between two second LEDs 112 with low brightness to increase overall light uniformity of the light emitting device 10.

The light emitting device uses a driver circuit to output different ratio of current to two groups of light emitting elements. Regardless being in the mixing light mode or the single color temperature mode (the first color temperature mode or the second color temperature mode), two groups of LEDs will illuminate to reduce the occurrence of bright band and dark band and increase light uniformity. Emitting lights with different color temperatures can be obtained through mixing when the much more different light emitting units are used.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting device, comprising:
a carrier board;
a first group of light emitting elements comprising a plurality of first LEDs disposed on the carrier board and used for emitting a first color temperature light;
a second group of light emitting elements comprising a plurality of second LEDs disposed on the carrier board and used for emitting a second color temperature light, wherein the first LEDs and the second LEDs are disposed in an alternative arrangement; and
a driver circuit used for outputting a first driving current and a second driving current to drive the first LEDs and the second LEDs respectively, wherein when the first driving current is the maximum, the second driving current is the minimum but not equal to zero, and when the second driving current is the maximum, the first driving current is the minimum but not equal to zero.

2. The light emitting device according to claim 1, further comprising a color temperature controlling interface coupled to the driver circuit and used for controlling magnitudes of the first driving current and the second driving current.

3. The light emitting device according to claim 2, wherein in a first color temperature mode selected through the color temperature controlling interface, when the first driving current is the maximum, the second driving current is the minimum but not equal to zero.

4. The light emitting device according to claim 2, wherein in a second color temperature mode selected through the color temperature controlling interface, when the second driving current is the maximum, the first driving current is the minimum but not equal to zero.

5. The light emitting device according to claim 1, wherein the first group of light emitting elements and the second group of light emitting elements are in parallel.

6. The light emitting device according to claim 5, wherein the first LEDs are in parallel.

7. The light emitting device according to claim 5, wherein the second LEDs are in parallel.

8. The light emitting device according to claim 1, wherein color temperature of the first color temperature light is different from that of the second color temperature light.

9. The light emitting device according to claim 8, wherein the first color temperature light is warm white, and the second color temperature light is cool white.

10. The light emitting device according to claim 8, wherein the first color temperature light is cool white, and the second color temperature light is warm white.
